(19) United States
(12) Patent Application Publication
(10) Pub. No.: US 2002/0063482 A1
(43) Pub. Date: May 30, 2002

(54) Starter generator

(76) Inventor: John W. Leslie, Miller Place, NY (US)

Correspondence Address: Thomas A. O'Rourke, Wyatt, Gerber & O'Rourke, L.L.P., 99 Park Avenue, New York, NY, 10016, US

(21) Appl. No.: 09/854,848

(22) Filed: May 14, 2001

Related U.S. Application Data
(63) Continuation-in-part of application No. 09/346,371, filed on Jul. 1, 1999.

(51) Int. Cl. H02K 5/00; H02K 1/00

(52) U.S. Cl. 310/89; 310/91

(57) ABSTRACT

A starter generator for a helicopter is disclosed. The starter generator has a body having a first end and a second end and a side wall between said ends. The side wall has a plurality of vents adjacent the first end of the body. The first end of the body has an end bell connected thereto and a commutator head assembly connected to the second end. A fan cover assembly is connected to the commutator head assembly. The end bell has a bearing liner with a rim extending therefrom toward the first end of the body such that the rim does not block any portion of a vent in the body.

This application is a continuation-in-part of U.S. application Ser. No. 09/346,371 filed on Jul. 1, 1999, the disclosures of which are incorporated herein by reference.

### BACKGROUND OF THE INVENTION

This invention relates to improvements in electric power systems for aircraft and, more particularly, to such systems which provide both starter and generator functions. The present invention has particular applicability to starter generators for helicopters. Typically, in airborne electrical power generation systems, it is desirable to have a single system which provides both the starter and generator functions. The weight and space savings on an aircraft can be substantial when a dedicated starter is eliminated. For this reason, electrical power generating systems which are capable of providing engine start functions can provide both cost and weight savings.

The starter-generator commonly utilizes a machine that combines an induction motor with a synchronous generator. In this machine, a rotor-shaped stator is positioned inside a squirrel-cage induction rotor which has an array of magnets attached on the outer diameter thereof. The compound/dual machine operates as a starter by using the induction rotor to accelerate the permanent magnet rotor up to some low synchronous speed, where ac power can be applied to the outside stator of the synchronous-generator so as to lock-in the permanent magnet rotor synchronously with the rotating field created in the armature (stator) of the synchronous-generator.

Frequently, the weakest link in the design of a starter-generator is the brushes. The carbon brushes utilized in starter-generators wear rapidly when brush temperatures exceed 450 degrees F. During startup, the starter generator brush temperatures can exceed 800 to 1000 degrees F or higher, thus significantly exceeding the 450-degree F threshold for rapid wear. The life of the starter-generator is frequently governed by the life of the brushes. With the development of higher horsepower turbine engines, the starter-generators utilized to start such engines have been experiencing rapid brush and armature commutator wear. Besides the cost of overhauling the starter generator after relatively short hours of use, the rapid wearing of the brushes causes a build up of carbon dust inside the starter generator, in the engine compartment and outside on the cowling as well.

### OBJECTS OF THE INVENTION

There is a need for improvements to a particular type of starter generator which is frequently used in helicopters. One common type of starter generator is a type sold by Aircraft Parts Corp. (APC) and also by Lucas and possibly by others. These starter generators are usually 150 amp generators and are characterized, because of the aircraft they are designed to be used on, as having a base that prevents the flow of air from exiting directly out the drive end of the starter generator. An example of this type of starter generator is shown in FIGS. 1 and 2. Because of their design, these generators have high maintenance and low hours between overhauls of the generator. These generators typically run hot and dirty, i.e., they generate high amounts of carbon dust due to the rapid wear of the brushes and this dust proliferates thus fouling the aircraft engine, cowling and compartments. In addition, these generators also produce copper dust from wear to the armature commutator. This dust is a good conductor and can potentially create shorts in the starter-generator. Because of the rapid wear of the brushes due to the carbon itself and the high operating temperatures of the starter generators, the generators must be repaired and overhauled frequently, at considerable cost and downtime.

Accordingly, it is an object of the present invention to provide improvements to starter generators that are designed such that air does not flow directly from the drive end of the starter generator.

It is an object of the present invention to provide an improved starter generator that requires low maintenance and has long brush life.

It is another object of the invention to provide an improved starter generator housing that permits the starter generator to better withstand higher temperatures thereby improving brush life.

Another object of the present invention is to provide an improved brush spring design that reduces armature, commutator and brush wear during operation of the starter generator.

A further object of the present invention is to provide a new brush composition and design that has provided longer brush life under diverse operating conditions.

### BRIEF DESCRIPTION OF THE DRAWINGS

FIG. 1 is a side view generally of the type of starter generator manufactured by APC and Lucas. These generators are sold, for example, under the designations APC 150SG Series and Lucas (LSI)23032 Series and others. This generator shows the end bell of the present invention.

FIG. 1A is an end view of the starter generator of FIG. 1,

FIG. 2 is side view of a prior art starter generator of the type manufactured by APC. These generators are sold under the designation, for example, APC 150SG 1 22C and others. This figure shows the end bell of the prior art.

FIG. 2A is an end view of the starter generator of FIG. 2.

FIG. 3 is a side view of the starter generator of the present invention.

FIG. 3A is an air-in end view of the starter generator of FIG. 3.

FIG. 4 is a side view of the starter generator of FIG. 2 with the improvements of the present invention.

FIG. 4A is an end view of the starter generator of FIG. 4

FIG. 5 is an end view of the fan cover assembly

FIG. 6 is a side view of the fan cover assembly of FIG. 5.

FIG. 7 is an end view of the drive end of an end bell of the starter generator of the present invention.

FIG. 7a is a cut away view of the end bell of FIG. 5 taken along section A-A.

FIG. 7b is a side view of the end bell of FIG. 5 taken along section B-B.

FIG. 8 is an end view of an alternate embodiment of an end bell of the starter generator of the present invention.

FIG. 8a is a cut away view of the end bell of FIG. 8 taken along section A-A.

FIG. 8b is a side view of the end bell of FIG. 6 taken along section B-B.

FIG. 9 is a side view of the commutator head assembly of the starter generator of the present invention.

FIG. 9a is partial blown up view of the detail of area A of the commutator head of FIG. 9.

FIG. 9b is a view of the commutator head of FIG. 9 taken along B-B.

FIG. 10 shows the brush spring of the present invention.

FIG. 11 shows the brush of the present invention.

FIG. 11a shows a side view of the brush of the present invention.

FIG. 11b shows the brush of FIG. 11 taken along A-A.

### DETAILED DESCRIPTION OF THE INVENTION

The present invention relates to starter generators for helicopters. The starter generators are preferably greater than two horsepower and more preferably greater than four horsepower and most preferably greater than five horsepower. In one embodiment, the starter generator is rated at 150 amps and 28 volts. Such starter generator has a wattage of 4200 watts, i.e., 5.61 horsepower. Preferably, the starter generators are rated at least 100 amps and more preferably, at least 150 amps. The volts of the starter generator can also vary. Preferably, the starter generator is at least 20 volts and more preferably greater than 25 volts and most preferably at least 28 volts.

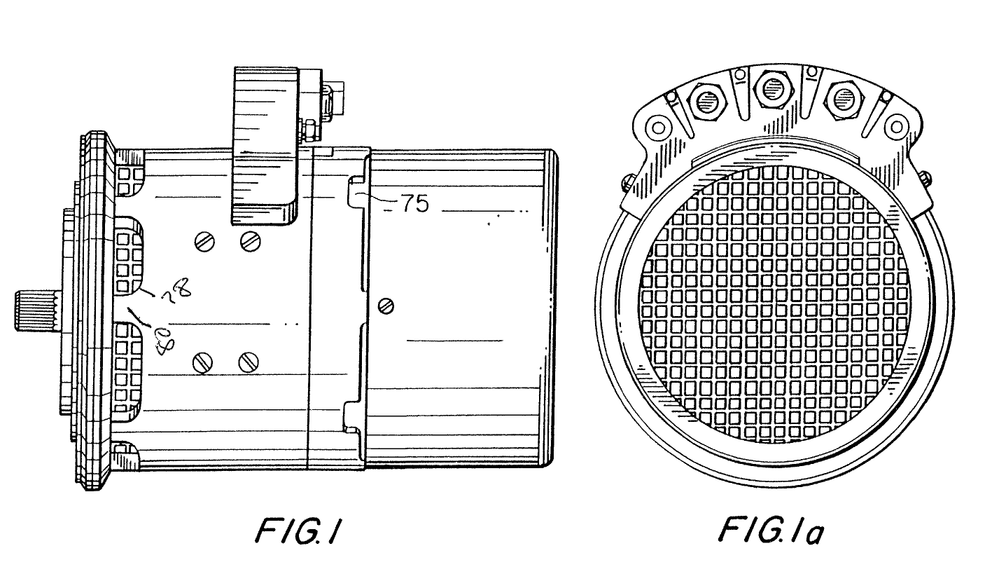

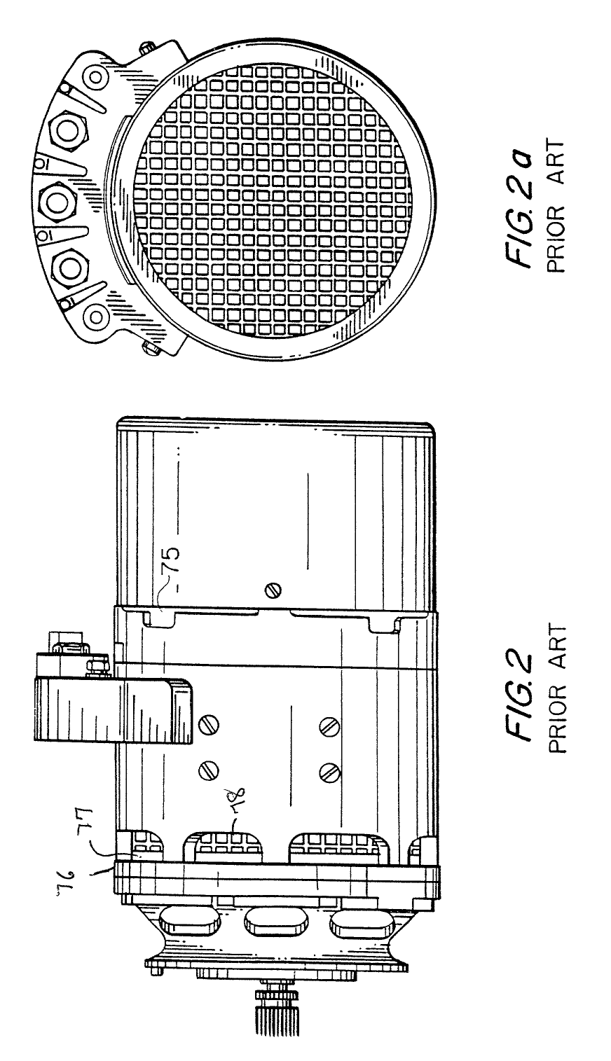

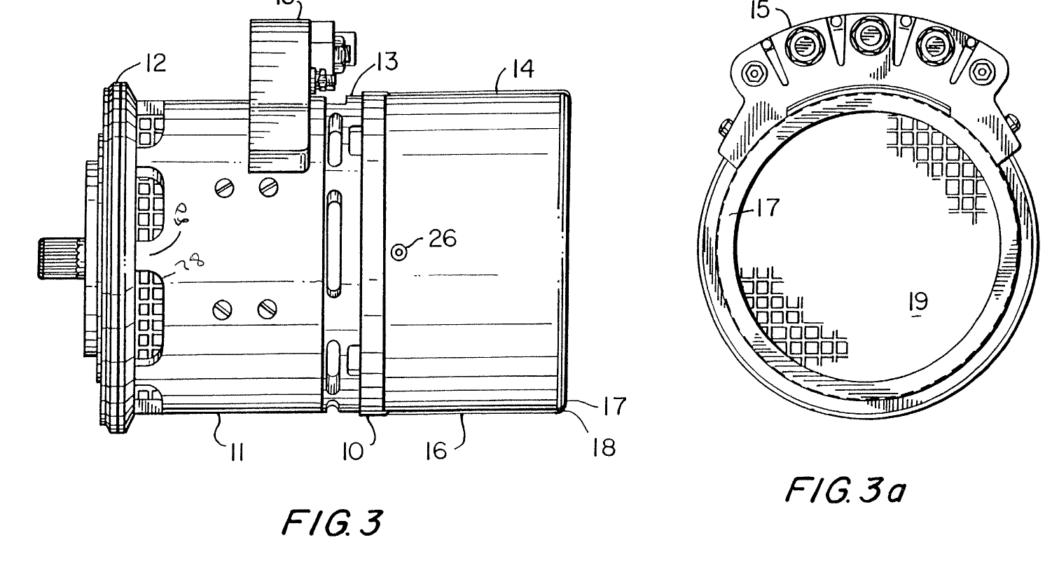

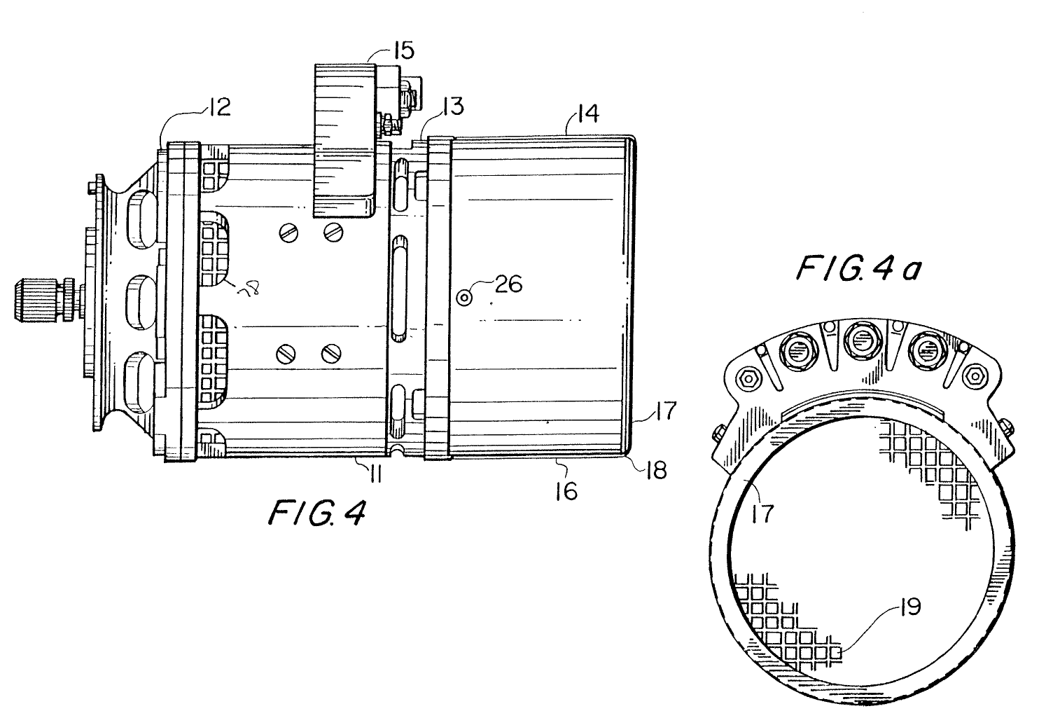

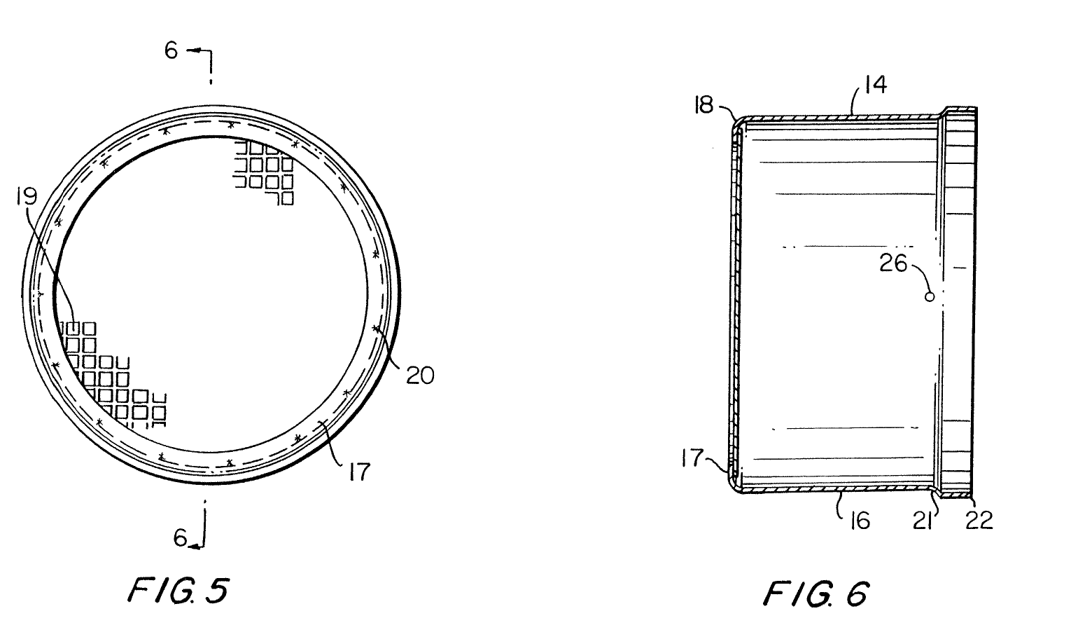

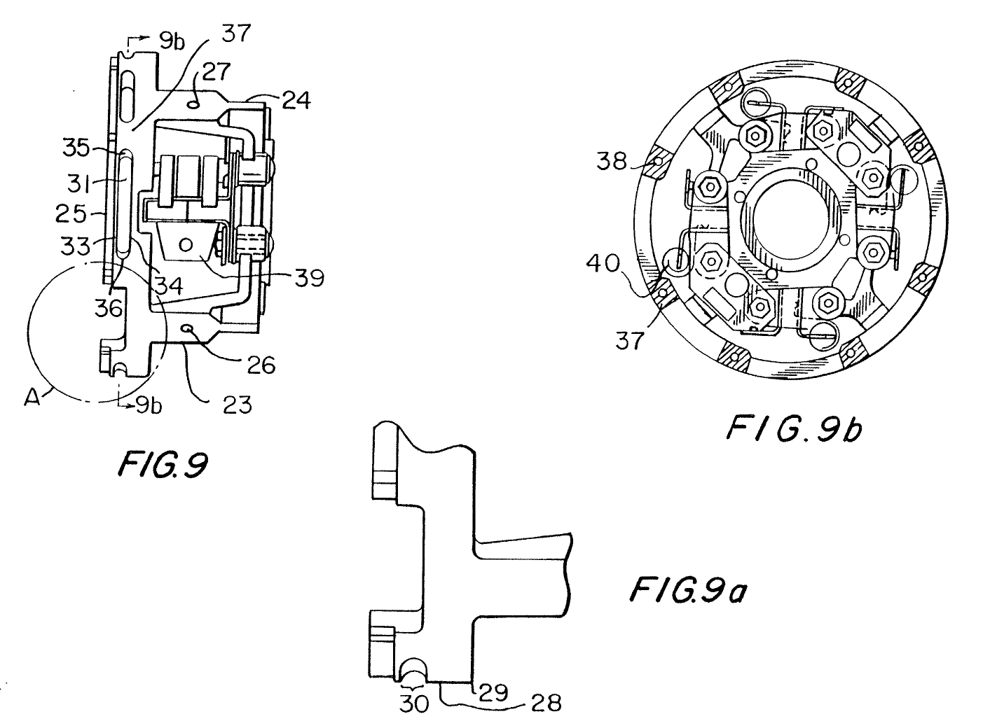

As shown in FIGS. 3 and 4 there is a starter generator 10 having a body 11 with an end bell 12, a commutator head assembly 13 and a fan cover assembly 14. Attached to the body 11 is a block 15 for making the appropriate electrical connections. The fan cover assembly 14 has a cylindrical body 16 with an inwardly extending flange or lip 17 about the circumference of the body at one end 18 of the body 16. The fan cover assembly 14 has an air inlet screen 19 to protect the fan and provide ventilation to the generator. The screen is typically connected to the fan cover assembly 14 by spot welding or other suitable means at a plurality of locations 20 along lip 17 of the fan cover. At the opposite end of the body (FIG. 6), there is a shoulder portion 21 and skirt 22. The shoulder portion 21 and 22 are adapted to receive a portion of the commutator head assembly 13. As shown in more detail in FIGS. 9a, 9b and 9c, commutator head assembly 13 has a frame 23 with a top end 24 and a base end 25. The top end 24 is adapted to fit within the fan cover assembly 14 and be retained therein by a suitable means such as screws that pass through screw holes 26 and 27 in the fan cover assembly 14 and commutator head assembly 13 respectively. The commutator head assembly has a side wall 28 at the base end 25 of the assembly. The side wall 28 has an upper portion 29 and a bottom portion 30. In the bottom portion 30 of the side wall are a plurality of slots 31 that are designed and placed so that air flows past the brushes in brush holder 39 and exits the starter generator. The presence of the channels is a particular advantage with respect to the inside brush in the starter generator as it typically runs considerably hotter than the outside brush and wears out more frequently as a result. Although the starter generators of the prior art FIGS. 1 and 2 have air outlet areas 75 these air outlet areas are placed in a position in the prior art starter generators to inefficiently exhaust the air past the brushes to reduce their operating temperature.

The presence of the slots in their position in the present invention provides significant increase in brush life. Whereas prior art brushes had a life of only 100 to 300 hours, it is not uncommon for the starter generators of the present invention to have brushes with a useful life of 1500 hours or more. In addition, because of the high temperatures in the prior designs, lengthening the brushes to add additional brush wear surface did not add significantly to the life span of the brushes. However, with the present invention, lengthening the brush from a length of 1.060 inches to 1.210 inches, a mere 5/32 inch, increases the useful life of the brush by at least an additional 400 hours over and above the increase of more than 1100 hours that the improvements of the present invention provide.

As seen in the FIGS. 3, 4 and 9, the slots are generally oval in shape although other shapes are possible. The slots have a pair or generally parallel sides 33 and 34 which are joined together by u-shaped end walls 35 and 36. By efficiently directing the air flow past the brushes, the high temperatures encountered by the brushes is considerably reduced thus decreasing wear and significantly extending brush life. The slots 31 pass through the side wall 28 and because of the curvature of the commutator head assembly the opening on the outer edge of the sidewall is wider than the opening on the inner edge. The slots have a length at the outside of the side wall in the range of approximately 1.75 to 2.00 inches and a height in the range of approximately 0.200 to 0.250 inches. The slots have a length at the inside of the side wall in the range of approximately 1.50 to 1.75 inch and a height in the range or approximately 0.200 to 0.250 inch. The length of each of the slots 31 should be as long as possible without unduly reducing the strength or support areas 37 which are adapted to receive a retaining means in orifice 38 for retaining the commutator head assembly in position with the body.

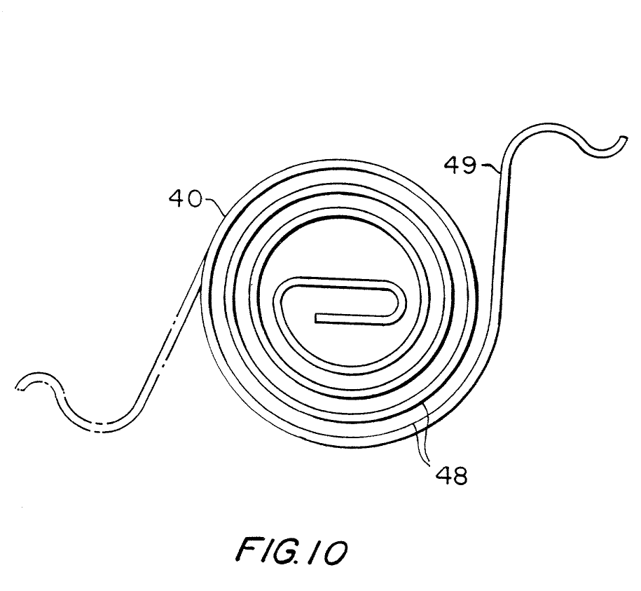

The commutator head typically has a brush holder 39 for receiving and retaining the brushes in position and a plurality of brush springs 40 which provide the brushes with the proper tension (see FIGS. 9, 10). The shoulder portion 21 and skirt 22 of the fan cover assembly 14 are adapted to receive a part of the upper portion 29 of the side wall of the commutator head assembly 13. However, the fan cover assembly should not extend over the opening of the slots 31. The position of the slots and their shape and size are such that they exhaust air entering the fan cover away from the brushes. Exhausting hot air reduces heat deterioration and wear of the armature/commutator and the brushes during operation.

At the end 41 of the body 11 opposite the commutator head assembly 13 is an end bell 12. As seen in FIG. 2 the prior art end bell 76 is provided with a rim 77 that extends from said end bell. One of the problems of the prior art end bells is that the rim 77 blocks the vents 78 by a substantial amount, thus reducing the amount of cooling air that may pass over the brushes. As shown in FIGS. 1, 3 and 4, the end bell of the present invention significantly increases the vent area of the vents 78.

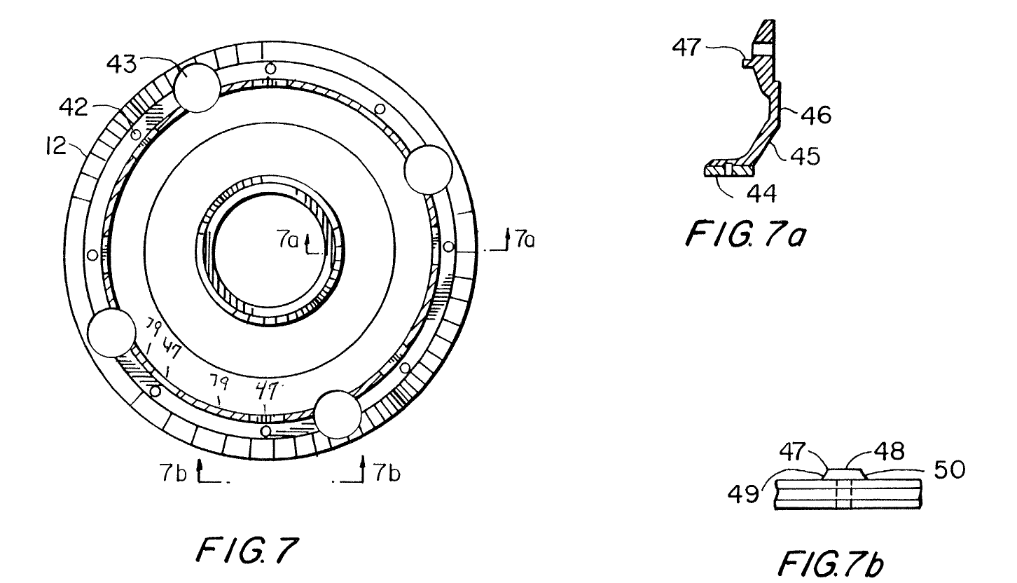

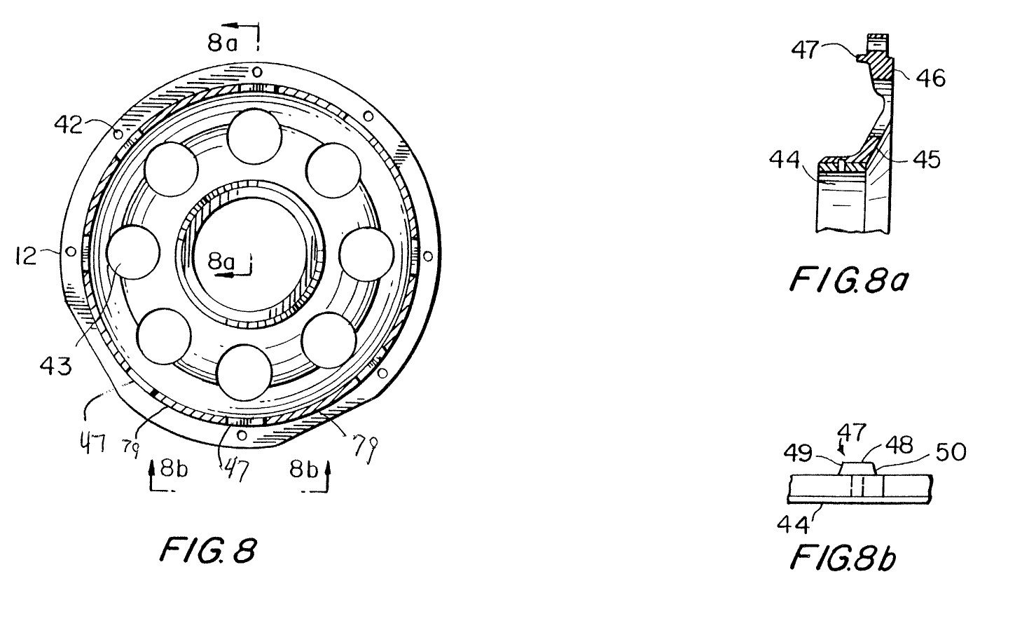

As shown in FIGS. 7 and 8 the end bell is generally disk shaped. The end bell of FIG. 7 is provided with a plurality of orifices 43 which provide clearance for bolts on the aircraft. In another end bell design, as shown in FIG. 8, the end bell has orifices added thereto over and above the amount of orifices necessary to provide clearance for the bolts on the aircraft, i.e., typically 4. These added orifices provide an additional area for air coming into from the fan cover to exit the area of the brushes. A second series of orifices 42 are used to attach the end bell to the body in both FIGS. 7 and 8. As seen in FIGS. 7a and 8a the end bell has a bearing liner 44. The bearing liner 44 is connected via a web 45 to side wall 46. Extending upwardly from sidewall 46 is support 47. The length of the support and sidewall is to be minimized so that the maximum air flow can be achieved through the orifices 57 in the body 11. The length of the cut out between the supports 47 should be approximately 1.75 to 2.00 inch. As seen in FIGS. 5B and 6B, support 47 extends up from the sidewall and has an upper surface 48 that is generally parallel to the bottom of the base. The side edges 49 and 50 of the support 47 may be perpendicular to the upper surface 48 or have a curvature as shown in FIGS. 7B and 8B. The support has a length of approximately 0.5″ as measured along the upper surface 48. The height of the support is about 0.135″ to 0.155″. As seen in FIG. 7 the rim of the prior art end bell has had material 79 removed therefrom leaving only support 47. The removal of the material 79 from the rim increases the air flow and adds to brush life. Brush life may also be increased by enlarging the vents 78 over and above the standard dimensions of the prior art starter generators. For example, the vents 78 may be widened such that the material 80 between each vent is approximately as wide as the width of the support 47 on the end bell. This increases the airflow as compared to prior art starter generators and increases brush life.

Inside the commutator head 13, as noted above, are a plurality of brush springs 40. The brush springs 40 have the general shape depicted in FIG. 10, i.e., a circular spring with a plurality of windings 48, In the prior art starter generators, the brush spring tension was high and the brushes were forced against the commutator. For example, the prior art brush spring had a tension force of 45-55 ounces or more. It has been found that the selection of the tension for the spring can be critical for superior brush life and reduced armature commutator wear. Proper tension on the spring results in longer brush life. The tension is measured by holding the spring in the position where the solid lines are and then rotating the tension bar 49 through a maximum of 165°. The tension force should be as low as possible and may preferably be in the range of 20 to 28 ounces or lower. Preferably the brush spring should be made from a corrosion resistant material such as a stainless steel.

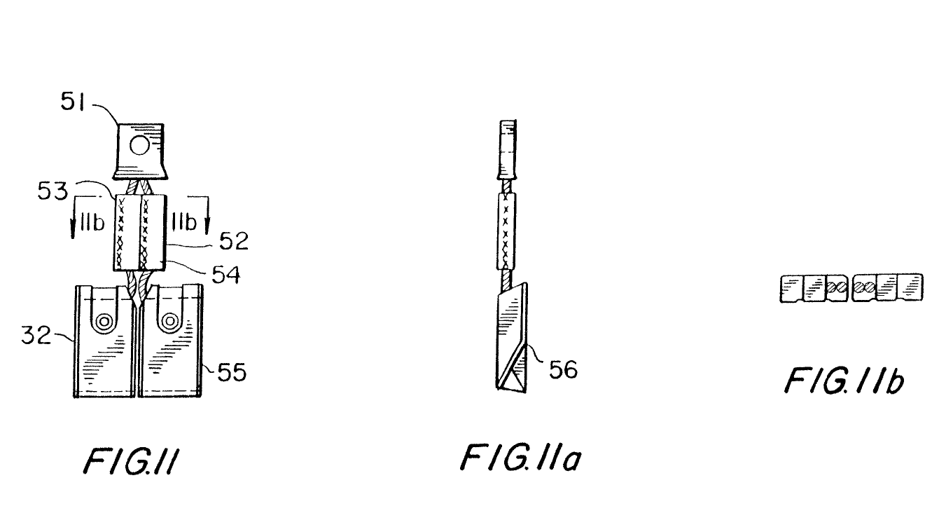

FIG. 11 depicts a typical brush arrangement of the present invention. The brush has a terminal 51 that connects to the brush holder 39. Extending from the terminal 51 are a pair of shunts 52 and 53 with usually about seven strands. The strands are preferably sheathed in a silicone fiberglass sheath 54. The brush 55 is usually provided with a mark or groove 56 that is used to measure wear.

The brush is preferably comprised of the following composition percentages by weight:

Boron <0.002 preferably <0.001

Iron <0.015 preferably 0.01

Copper <0.002 preferably <0.001

Molybdenum <0.002 preferably <0.001

Magnesium <0.02 preferably <0.01

Silicon <0.015 preferably 0.01

Silver <0.60 preferably 0.56

Aluminum <0.002 preferably <0.001

Calcium <0.15 preferably <0.10

Phosphorous <0.02 preferably <0.01

Sulfur <0.02 preferably <0.01

Potassium <0.02 preferably <0.01

Nickel <0.002 preferably <0.001

Cobalt <0.002 preferably <0.001

Manganese <0.002 preferably <0.001

Titanium <0.002 preferably <0.001

Vanadium <0.002 preferably <0.001

Zinc <0.02 preferably <0.01

Lead <0.02 preferably <0.01

Lithium <2.0 preferably <1.0, most preferably about 0.50 to 0.60

Lithium carbonate <5.0 preferably <4.0, most preferably about 3.00 to 4.00

The remainder is carbon.

The brush length is usually about 1.06 long, however, because of the reduced spring tension and lower operating temperatures of the design of the present invention a brush length of 1.210 may be used. However, it will be appreciated that longer and shorter brush lengths may be used.

### EXAMPLE 1

A starter generator made in accordance with the present invention was installed on a helicopter engine. At the same time a competing starter generator was installed on a similar helicopter. Both helicopters were in service for 100 hours of typical use. The engine compartment of the helicopter using the competing product had to be washed down frequently to remove carbon dust from the generator and engine compartment. The helicopter employing the present invention did not have to be so cleaned. After the 100 hours of use transpired the starter generators were inspected. The competing product was covered with carbon dust. The starter generator of the present invention was not. The brushes of both starter generators were examined after 100 hours of use. The competing starter generator had significant brush wear and was estimated to have only approximately 200 additional hours of wear remaining. The starter generator of the present invention had minimal wear and was estimated to have approximately 1700 hour of additional wear remaining based on the current rate of wear.

### EXAMPLE 2

Table 1 depicts the brushes that are used in specific starter generators. The tension in the brush spring was obtained directly from the OEM Overhaul Manuals. The area of the brush that makes contact with the commutator was calculated and indicated in the table as “Brush Size per sq. in.” Based on the tolerance of the brush spring tension and the area of the brush the low, average and high value of the pressure on the brush from the brush spring can be calculated. The average brush spring pressure on the starter generators of the present invention is 119.65 oz/sq. in. The average brush spring pressure on the prior art starter generators is 199 oz/sq. in. causing OEM brushes to typically last a maximum of approximately 300 hours between brush changes. Brush spring tension is determined by the following formula:

Stress×Area=Force

119.65 oz/sq. in×0.201 sq. in.=24.05 oz average

Using Table 1 the tension for the brush spring can be calculated to match the desired tension in a known brush spring. If the size of the brush is known, i.e., N1829-1 Brush=0.201 sq. in. then the tension on the brush spring is: 119.65 oz/sq. in.×0.201 sq. in.=24.05 oz. Preferably, the pressure exerted by the brush springs on the commutator is in the range of about 90 to 150 oz./sq. in, and more preferably 100 to 130 oz./sq. in, and in a most preferred range of 110-125 oz./sq. in,

TABLE 1
BRUSH SPRING ANALYSIS
COMPARISONS OF BRUSH SPRING TENSION

| | | SPECIFIED | | SPRING | SPRING | SPRING |
|---|---|---|---|---|---|---|
| | | TENSION/ | BRUSH | PRESSURE | PRESSURE | PRESSURE |
| BRUSH | STARTER | OVERHAUL | AREA | LOW | AVERAGE | HIGH |
| PART NUMBER | GENERATOR | MANUAL | SQ. IN. | OZ/SQ IN | OZ/SQ IN | OZ/SQ IN |
| N1828-1 | 23032-1022 | 40-56 oz | .294 | 136.05 | 163.26 | 190.48 |
| N1828-1 | 150SG121Q | 32-48 oz | .294 | 108.84 | 136.06 | 163.27 |
| 23032-1380 | 23032-010 | 32-48 oz | .201 | 159.20 | 199.00 | 238.81 |
| 150SG1009-5 | 150SG111Q | 32-48 oz | .201 | 159.20 | 199.00 | 238.81 |
| N1830-1 | 23081-018 | 28-40 oz | .237 | 118.14 | 143.46 | 168.78 |
| N1830-1 | 200SGL118Q | 30-39 oz | .237 | 126.58 | 140.57 | 164.56 |
| N1831-1 | 23048-001 | 40-55 oz | .397 | 100.76 | 119.65 | 138.54 |
| N1831-1 | 250SG111Q | 40-55 oz | .397 | 100.76 | 119.65 | 138.54 |
| N1831-1 | 23079-000-1 | 50-64 oz | .397 | 125.94 | 143.57 | 161.21 |
| N1831-1 | 300SGL119Q | 40-55 oz | .397 | 100.76 | 119.65 | 138.54 |
| N1831-1 | 300SGL116Q | 40-55 oz | .397 | 100.76 | 119.65 | 138.54 |

Example: Using the table above, calculate the tension for a new brush spring that matches
the desired tension in a known brush spring.
A new brush spring will be designed that will apply the same pressure on the brushes as the brushes in a
300SGL116Q. From the table above, the pressure on the brushes of a 300SGL116Q Starter-Generator =
119.65 oz/sq in.
If the size of the brush is known, such as the N1829-1 Brush = .201 sq in.

| | Stress | × Area | = Force |
|---|---|---|---|
| Then the tension on the brush spring is: | 119.65 oz/sq in. | × .201 sq in | = 24.05 oz |

I claim

1. In a starter generator having a body said body having a first end and a second end and a side wall between said ends, said side wall having a plurality of vents adjacent the first end of said body, said first end having an end bell connected thereto and a commutator head assembly connected to said second end, and a fan cover assembly connected to said commutator head assembly, the improvement comprising said end bell having a bearing liner, said bearing liner having a rim extending therefrom toward said first end of said body such that said rim does not block any portion of a vent in said body, said end bell being adapted to be connected to a helicopter body.

2. In a starter generator having a body said body having a first end and a second end and a side wall between said ends, said side wall having a plurality of vents adjacent the first end of said body, said first end having an end bell connected thereto and a commutator head assembly connected to said second end, and a fan cover assembly connected to said commutator head assembly, the improvement comprising said end bell having a bearing liner, said bearing liner having a support extending therefrom toward said first end of said body such that said support does not block any portion of a vent in said body, said end bell being adapted to be connected to a helicopter body.

3. The starter generator according to claim 1 wherein said end bell is generally disk shaped and has a top surface and a bottom surface said top and bottom surfaces being connected by a sidewall, said top and bottom surfaces having a plurality of orifices for providing clearance for bolts on a helicopter said end bell having more orifices in said top and bottom surfaces than those orifices that are required for connecting said starter motor to said helicopter, said additional orifices providing increased ventilation for brushes in said commutator head assembly.

4. The starter generator according to claim 2 wherein said end bell is generally disk shaped and has a top surface and a bottom surface said top and bottom surfaces being connected by a sidewall, said top and bottom surfaces having a plurality of orifices for providing clearance for bolts on a helicopter said end bell having more orifices in said top and bottom surfaces than those orifices that are required for connecting said starter motor to said helicopter, said additional orifices providing increased ventilation for brushes in said commutator head assembly.

5. The starter generator of claim 2 wherein the support has an upper surface generally parallel to said bottom surface of said end bell and a pair of side walls.

6. The starter generator according to claim 5 wherein are generally perpendicular to said upper surface.

7. The starter generator according to claim 5 wherein the side edges are curved.

8. The starter generator according to claim 5 wherein the upper surface of said support has a length of approximately 0.5″

9. The starter generator according to claim 8 wherein the support has a height in the range of about 0.135″ to 0.155″.

10 A starter generator according to claim 1 wherein the starter generator has one or more brushes that comprise the following percentages by weight
Boron <0.002
Iron <0.015
Copper <0.002
Molybdenum <0.002
Magnesium <0.02
Silicon <0.015
Silver <0.60
Aluminum <0.002
Calcium <0.15
Phosphorous <0.02
Sulfur <0.02
Potassium <0.02
Nickel <0.002
Cobalt <0.002
Manganese <0.002
Titanium <0.002
Vanadium <0.002
Zinc <0.02
Lead <0.02
Lithium <2.0
Lithium carbonate <5.0
and wherein the remainder is carbon.

11. A starter generator having one or more brushes wherein the brushes comprise the following percentages by weight:
Boron <0.002
Iron <0.015
Copper <0.002
Molybdenum <0.002
Magnesium <0.02
Silicon <0.015
Silver <0.60
Aluminum <0.002
Calcium <0.15
Phosphorous <0.02
Sulfur <0.02
Potassium <0.02
Nickel <0.002
Cobalt <0.002
Manganese <0.002
Titanium <0.002
Vanadium <0.002
Zinc <0.02
Lead <0.02
Lithium <2.0
Lithium carbonate <5.0
and wherein the remainder is carbon, said starter generator being adapted for use in a helicopter.

12. The starter generator according to claim 2 wherein the starter generator has one or more brushes that comprise the following percentages by weight
Boron <0.001
Iron ≦0.01
Copper <0.001
Molybdenum <0.001
Magnesium <0.01
Silicon ≦0.01
Silver ≦0.56
Aluminum <0.001
Calcium <0.10
Phosphorous <0.01
Sulfur <0.01
Potassium <0.01
Nickel <0.001
Cobalt <0.001
Manganese <0.001
Titanium <0.001
Vanadium <0.001
Zinc <0.01
Lead <0.01
Lithium <1.0
Lithium carbonate <4
and wherein the remainder is carbon.

13. The starter generator according to claim 11 wherein the percentage of Lithium by weight is about 0.50 to 0.60.

14. The starter generator according to claim 13 wherein the percentage of Lithium carbonate by weight is about 3.00 to 4.00.

15. The starter generator according to claim 1 further comprising a brush spring having a tension on a commutator of less than 40 ounces.

16. The starter generator according to claim 15 wherein the brush spring has a tension on the commutator of less than 28 ounces.

17. The starter generator according to claim 1 wherein a brush spring has a tension on a commutator of less than 20 ounces.

18. A starter generator comprising
a body having a first end and a second end having an end bell at said first end,
a commutator head assembly at said second end and
a fan cover assembly on said commutator head assembly opposite said body said starter generator being adapted to be connected to a helicopter, and
wherein there are one or more brushes in the starter generator and wherein the pressure exerted by a brush spring on a commutator is in the range of about 90 to 150 oz./sq. in.

19. The starter generator according to claim 18 wherein the pressure exerted by said brush spring is in the range of about 100 to 130 oz./sq. in,

20. The starter generator according to claim 19 wherein the pressure exerted by said brush spring is in the range of about 110-125 oz./sq. in,

21 The starter generator according to claim 18 having a horsepower greater than two.

22. The starter generator according to claim 21 having a horsepower greater than four.

23. The starter generator according to claim 22 having a horsepower greater than five.
